(19) United States
(12) Patent Application Publication
(10) Pub. No.: US 2010/0319518 A1
(43) Pub. Date: Dec. 23, 2010

(54) Systems and methods for collaborative music generation

(76) Inventor: Virendra Kumar Mehta, Cupertino, CA (US)

Correspondence Address: Goodwin Procter LLP;Attn: Patent Administrator, 135 Commonwealth Drive, Menlo Park, CA, 94025-1105, US

(21) Appl. No.: 12/820,291

(22) Filed: Jun. 22, 2010

Related U.S. Application Data
(60) Provisional application No. 61/219,649, filed on Jun. 23, 2009.

(51) Int. Cl. G10H 1/08

(52) U.S. Cl. 84/625

(57) ABSTRACT

A new approach is proposed that contemplates systems and methods to enable a musician to connect with other musicians online in a social network, or work with their past work that is available to use. The musicians may use an in-browser mixer to select tracks from the site for a specific song, change their individual settings like volume, starting positions, pan and the like, mix tracks and play them together, and then record their own track alongside. A musician may also connect with other musicians online in a social network, or work with their past work that is available to use.

### RELATED APPLICATIONS

This application claims the benefit of U.S. Provisional Patent Application No. 61/219,649 filed Jun. 23, 2009, which application is fully incorporated herein by reference.

### BACKGROUND

1. Field of the Invention

This invention relates generally to provide systems and methods that enable a musician to connect with other musicians online in a social network, or work with their past work that is available to use.

2. Description of the Related Art

Most musicians tend to find each other in social circles or school and professional environments. They then get together in someone's garage, usually at the place of the one with the heaviest instruments like drums, or the person with the least amount of available time (and thus avoid the commute time). They practice as often as possible, and eventually, on perfection, make their way to a recording studio, where one by one, they record their tracks. A sound engineer, typically one of the musicians, eventually works on the mix and mixes down to a song.

Since the advent of analog-to-digital converters, and electronic music instruments, it has been relatively easy to record a track on a computer. Each of the musicians can record their instrument on a computer and store it as a file. These files can be emailed around and someone can put them all together and create a song out of them.

There are other solutions which make the sending of files easier by allowing file sharing. Musicians can log on to the sites, download the files, mix them locally on their computers and play and record their tracks locally.

There are websites that act as social networks and allow musicians to get together online and find each other to collaborate on music. By file sharing with other musicians, they can create music together.

The problem with offline solutions is that it is difficult to find musicians of compatible skill level and musical preference, coordinate schedules to meet and expensive and time consuming to rent out a studio and record. Over time, people may need to move away due to job or other personal changes. This breaks a group like this up and it is non-trivial for another to form.

File sharing sites can allow users to create content together however it is non-trivial to download all these files. Each individual track can be tens of megabytes and that can be a significant enough deterrent that users either do not try it, or pre-mix the tracks to reduce the amount of download. This reduces their ability to alter the contents after downloading.

Mixing the tracks on a computer needs a powerful processor and a lot of memory. If a musician wants to record music while listening to a mixed version of all the tracks, this requires additional computer power and as the number of tracks increases this makes it difficult to record at the same time as the other tracks are mixing.

Accordingly, there is a need for an end-to-end solution which makes it easier to create music collaboratively without needing the musicians to meet and play together. Musicians want ways to collaborate with other musicians in order to create music. However this tends to be very hard in practice and there are quite a few issues.

They need to find a team to play and practice with, and they need a common practicing place which can accommodate everyone and their instruments as well as make it easier to get the instruments to such a place. They also need a common time when everyone can get together and play. They need to find folks with the same skill set as them and people who can complement their skills. Once they are done practicing, they need easy access to recording studios to convert their music into something that can be published. At that point, they need their recording to be the best out of all the previous plays done during practice. The fact that the ‘best’ of all practice sessions converts to a recordable song automatically, without the need to ‘bring their best’ on the day they show up at the recording studio is a significant change from the way things are done today.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of an overall system architecture that supports collaborative music generation.

FIG. 2 depicts a flowchart of an example of a process to support user interaction for mix and play.

FIG. 3 depicts a flowchart of an example of a process to support user interaction for recording.

FIG. 4 depicts a flowchart of an example of a process to support database and track store.

FIG. 5 depicts a flowchart of an example of a process to support stateless mix server.

FIG. 6 depicts a flowchart of an example of a process to support stateful mix server.

FIG. 7 depicts a flowchart of an example of a process to support user interaction with the mixer.

FIGS. 8-10 depict screenshots of examples of user interfaces that support collaborative music generation.

FIG. 11 depicts a web portal that provides service for collaborative music generation.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

An object of the present invention is to provide systems and methods that enable a musician to connect with other musicians online in a social network, or work with their past work that is available to use.

An object of the present invention is to provide systems and methods that enable musicians to record tracks which are uploaded and stored online.

Another object of the present invention is to provide systems and methods that enable musicians, using an in-browser mixer, to select tracks from the site for a specific song, change their individual settings like volume, starting positions, pan and the like.

A further object of the present invention is to provide systems and methods that enable musicians to mix tracks and play them together, and then record their own track alongside.

Yet another object of the present invention is to provide systems and methods that enable all the tracks on a site to be pre-mixed in real time at a server, with the compressed version streamed back.

Still another object of the present invention is to provide systems and methods that enable any local tracks that are part of a mix to be mixed locally on the system along with the stream of remote mixed tracks.

An object of the present invention is to provide systems and methods that enable pre-mixing tracks on a server in order to save compute power of the musicians' computer and allow it to focus on recording and control the mix UI effectively.

A further object of the present invention is to provide systems and methods that enable real time mixing and allow for changes to be made to individual tracks during a playback.

Still a further object of the present invention is to provide systems and methods that enable streaming of a mix down version that reduces the amount of bandwidth required, and enable a user to play a mix with a lot of tracks using a relatively slower connection.

Another object of the present invention is to provide systems and methods that enable the best version of a track to also be the final/production version without requiring a separate session in the recording studio.

The overall system architecture contains several computer systems interconnected using internet. Each of them has associated storage space. There are different actions performed at the different systems. The musician's computer system is called the client computer. It has an operating system, a browser, associated storage, and a network connection, usually a broadband connection from home to the internet providers.

The client connects to a computer that holds the website for the system of the present invention. The website runs a web server which serves the files corresponding to a web application. The web application allows the client to log on to the website, explore the various messaging boards and forums, sort through various songs, artists, and mixes, and finally launch a music mixer application.

The music mixer application runs inside the client's browser application. It can also run standalone as a desktop application on the client computer. The mixer connects to a database server. The database server provides the information related to a set of tracks that together make up a mix. The mixer application uses this information to draw the tracks on the screen along with controls to manipulate them. It then sends a request to a mix server along with the list of tracks and associated information like volume of each track, starting position etc.

The database server keeps metadata information about the tracks in a database along with information about mixes owned by different musicians. It also runs a web application that allows an external program to manipulate the database by calling various services of this application.

The mix server runs a mixer application which mixes different tracks, compresses the output, and sends it over internet to a requesting client. This application accesses the sound files corresponding to all tracks, uses an algorithm to mix the samples of all these files after adjusting their individual starting positions, volumes, panning, and other attributes as they apply to the specific mix. In some cases, the track files may be sitting on a separate network storage and the mixer application would first download them locally and cache them.

There is a vast amount of storage connected to the mixer and database servers. This space can be increased or lowered on demand. The storage space is used to save all the track files. They are sent to different mixer servers on demand and can be cached on the servers for faster access. The ability to increase and reduce the computing power and data storage space is provided by a grid, also known as a cloud.

The client computer is also used for recording of a track. A musical instrument is connected to the computer using an audio interface. The musician can play the mix in the browser and while doing so, can record one or more tracks. After recording, these tracks are uploaded to the mixer server. The mixer server caches a copy of the server locally and then uploads it to the large separate storage space.

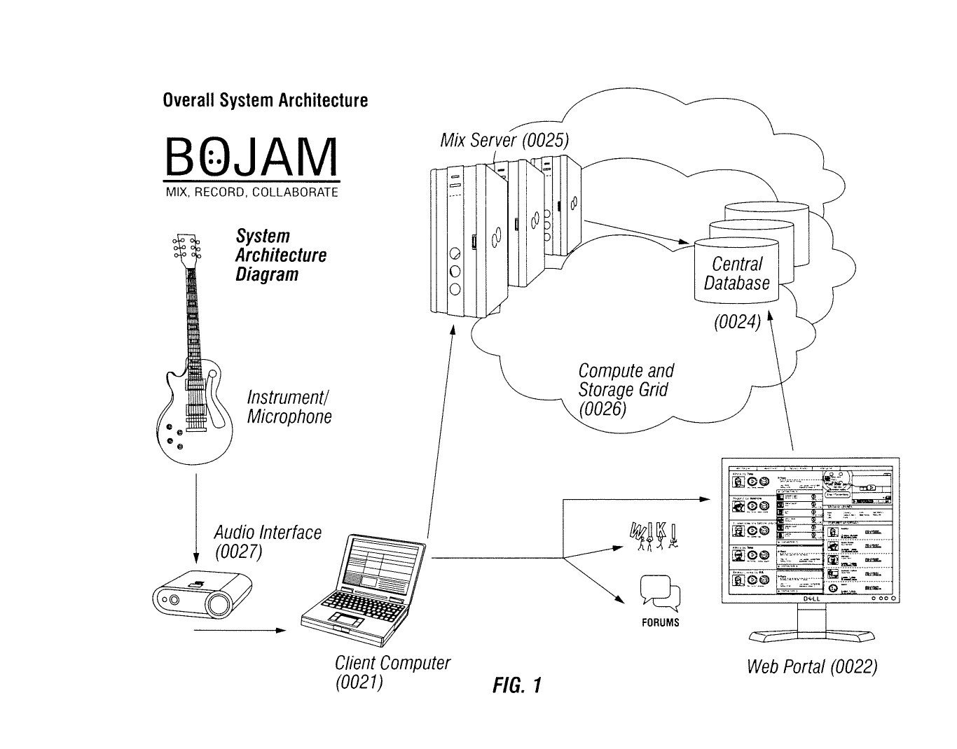

FIG. 1 depicts an example of an overall system architecture that supports collaborative music generation, where a user can log on to the website, sort through and select the mix and then launch the mixer. This diagram describes the steps taken by a user using the client computer (0021) to connect to the website (0022) and the system's responses to log on to the website, explore the different mixes available, go to the forum and post messages, select an interesting mix, and then launch to perform mixing and recording.

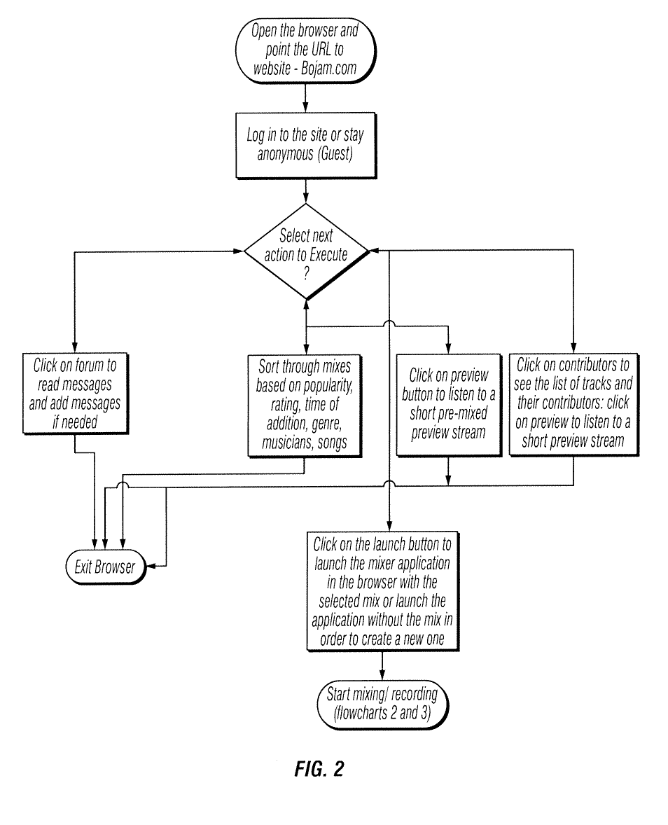

FIG. 2 depicts a flowchart of an example of a process to support user interaction for mix and play. This flow chart describes the user's interaction using the client computer (0021) with the website (0022), the database (0024) and the mix server (0025) using the mixer application running inside the browser which connects to the other entities over the internet.

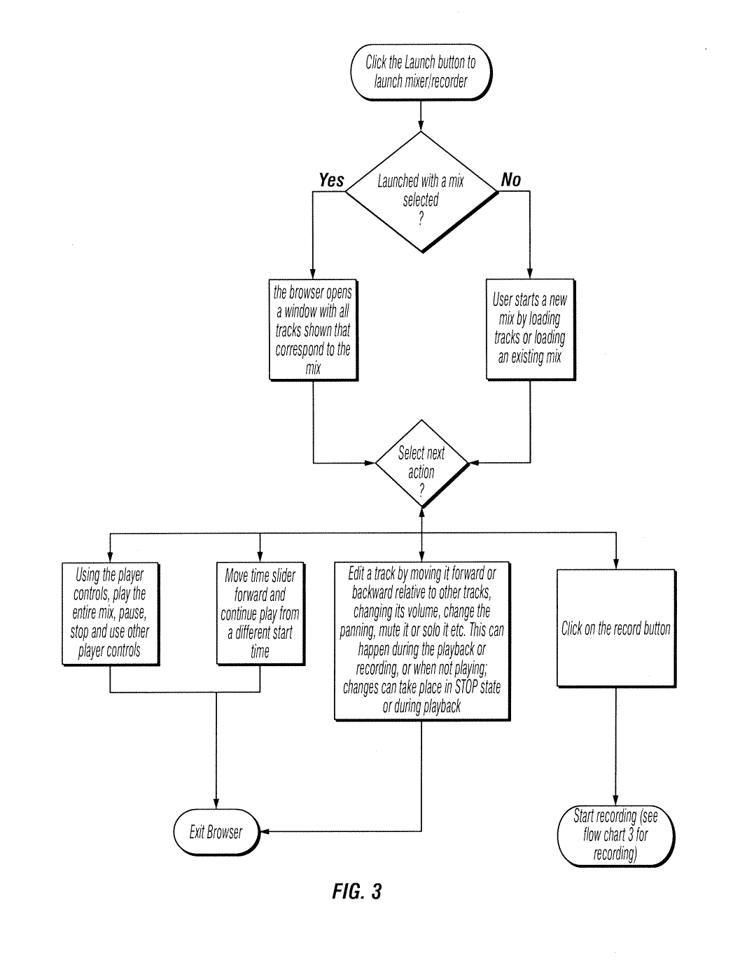

FIG. 3 depicts a flowchart of an example of a process to support user interaction for recording. This flowchart describes the process followed by the user to record a track and the system's interaction. The user connects the instrument through an audio interface (0027) to the client computer, turns the appropriate controls on in the in-browser mixer after downloading a plug-in and starts recording. After recording, the user uses controls that either upload the track to online storage space or keep it locally for future use.

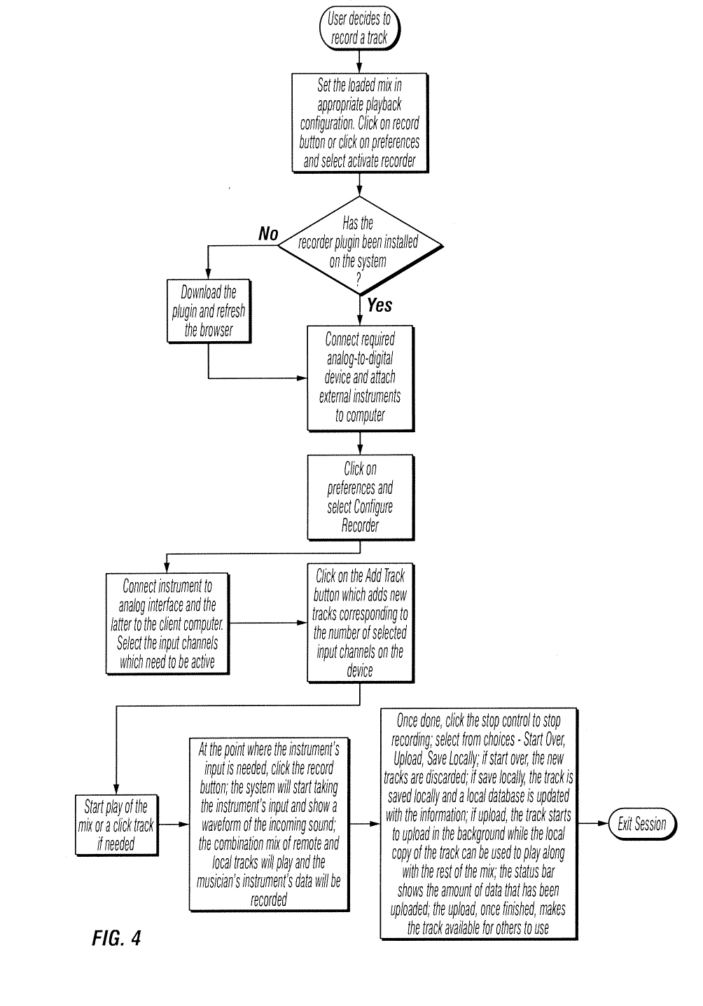

FIG. 4 depicts a flowchart of an example of a process to support database and track store. This flowchart describes the way user interaction with the in-browser mixer and the plug-in from the client computer ends up causing actions at the database server and data storage side. The database server maintains the metadata related to the mixes, songs, tracks, clips etc in a database and uses an expandable storage space to keep the tracks that have been uploaded by the user after recording.

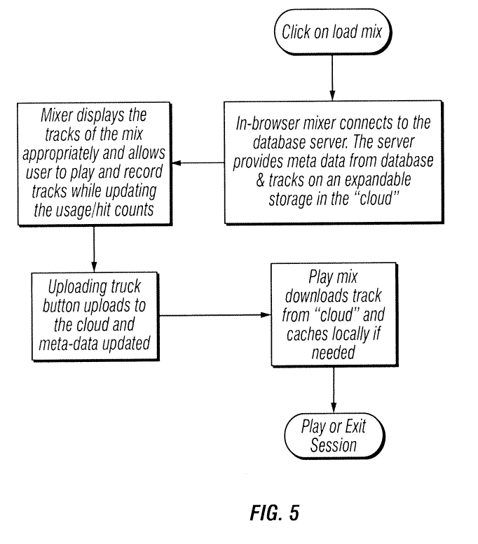

FIG. 5 depicts a flowchart of an example of a process to support stateless mix server. This flowchart describes the way a stateless mix server operates to provide a mix to the in-browser mixer. The big distinction with the stateful mix server is that the state of current user mix console is maintained entire on the client computer and sent to the back end server along with a mix request. A new mix server is created to handle this request which exits after the request is handled and the state information is removed. The next request would lead to creation of a new mix server.

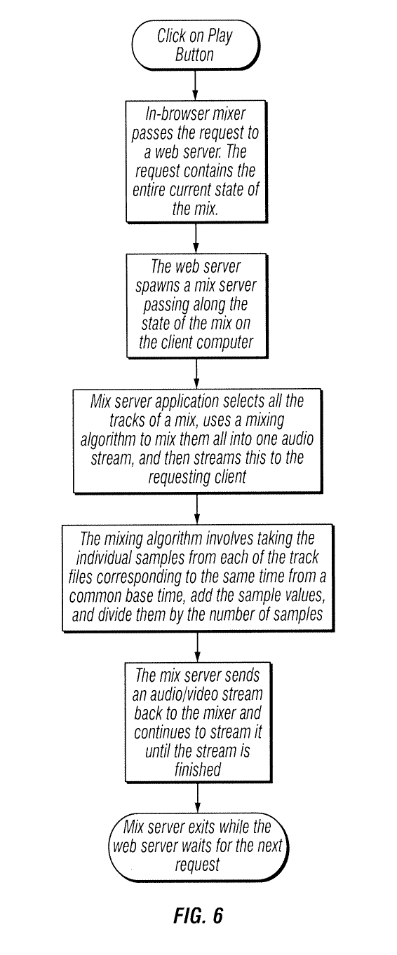

FIG. 6 depicts a flowchart of an example of a process to support stateful mix server. This flowchart describes the user's actions corresponding to a stateful mix server on the backend and the stateful mix server's behavior in return. This server differs from the stateless server in the sense that it retains a copy of the state of the in-browser mixer as the user uses different controls and takes different actions. This allows the server to create an audio/video stream when a request comes without first figuring out the state embedded in the request. It also allows the mix server to be prepared for such a request by pre-loading tracks that are being selected by the user even before the play button is clicked.

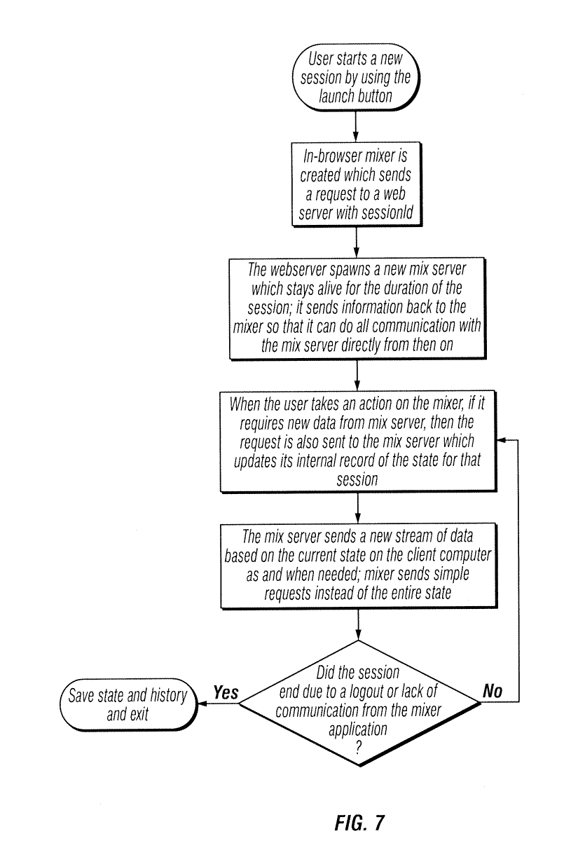

FIG. 7 depicts a flowchart of an example of a process to support user interaction with the mixer.

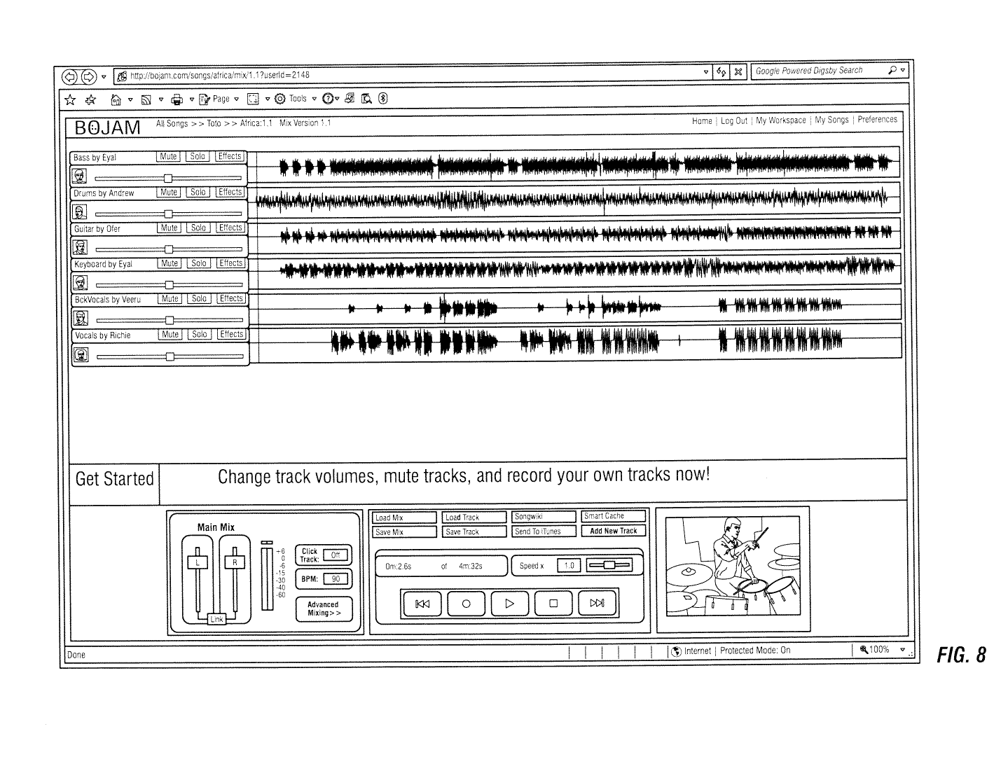

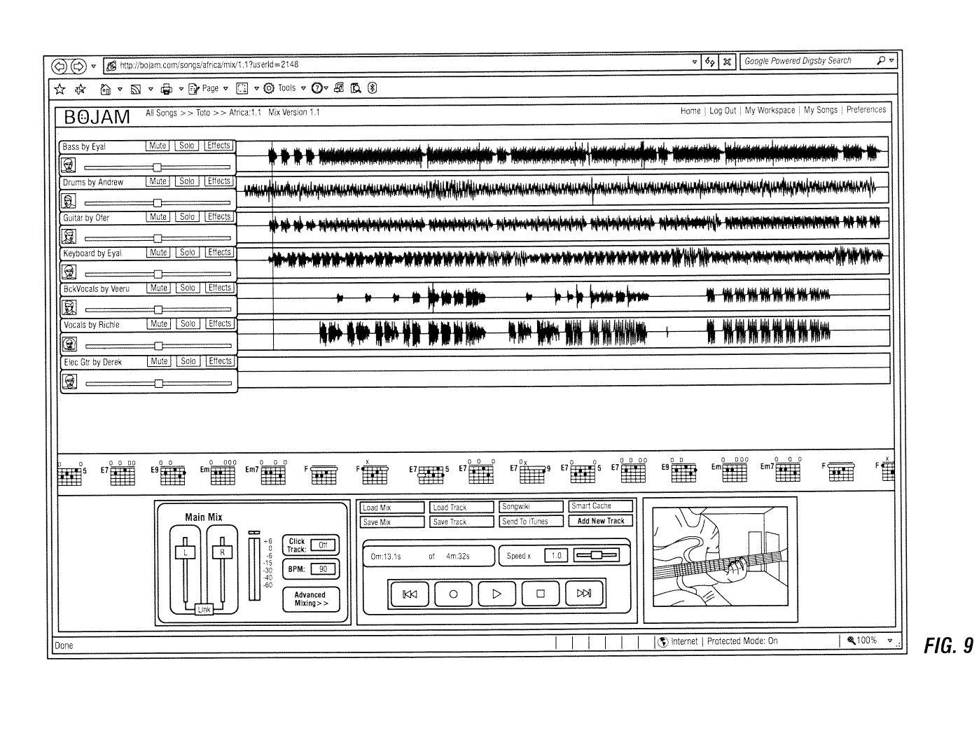

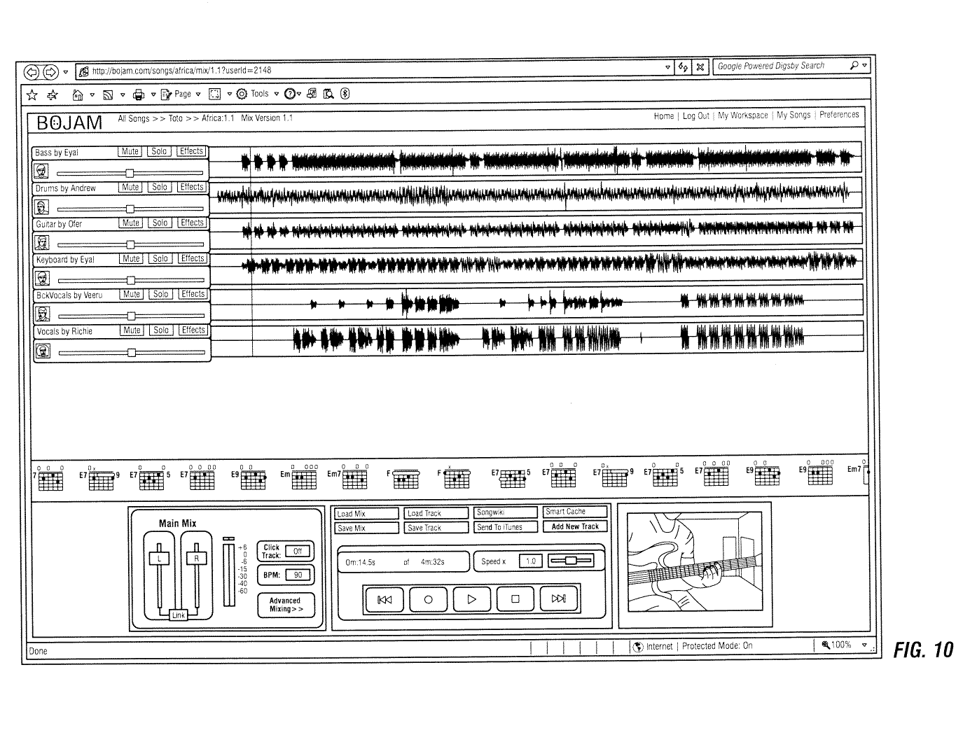

FIGS. 8-10 depict screenshots of examples of user interfaces that support collaborative music generation.

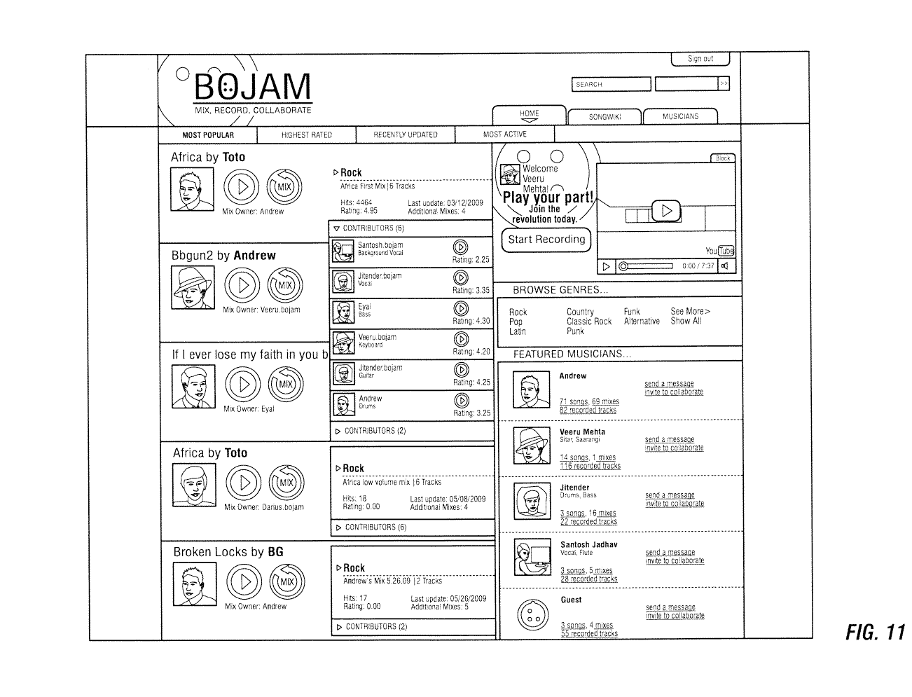

FIG. 11 depicts a web portal that provides service for collaborative music generation.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

1. A computer-implemented method, comprising:
enabling a user to log on to the website;
exploring different mixes available;
selecting an interesting mix; and
launching a mixer to perform mixing and recording.
